(19) United States
(12) Patent Application Publication
(10) Pub. No.: US 2025/0239025 A1
(43) Pub. Date: Jul. 24, 2025

(54) AUGMENTED REALITY DEVICE FOR DISPLAYING CONTEXTUAL INFORMATION ABOUT AN AUDIO SIGNAL

(71) Applicant: Google LLC, Mountain View, CA (US)

(72) Inventors: Raymond Kirk Price, Carnation, WA (US); Dongeek Shin, San Jose, CA (US)

(21) Appl. No.: 18/418,748

(22) Filed: Jan. 22, 2024

(51) Int. Cl. G06T 19/00; G10L 15/26; G10L 21/0208

(52) U.S. Cl. CPC G06T 19/006; G10L 15/26; G10L 21/0208

(57) ABSTRACT

A display device may detect an ambient sound from audio data captured by a plurality of microphones on a display device. A display device may determine, based on the audio data, a location of a sound source of the ambient sound. A display device may generate contextual information about the ambient sound based on an audio segment of the audio data that includes the ambient sound. A display device may display the contextual information based on the location of the sound source.

### BACKGROUND

Augmented reality (AR) is a technology that superimposes virtual content on a user's view of the real world, thereby providing a composite view. A conventional AR device may convert speech to text, and the written transcription may be rendered in a predetermined portion of the display.

### SUMMARY

In some aspects, the techniques described herein relate to a method including: detecting an ambient sound from audio data captured by a plurality of microphones on a display device; determining, based on the audio data, a location of a sound source of the ambient sound; generating contextual information about the ambient sound based on an audio segment of the audio data that includes the ambient sound; and displaying, by the display device, the contextual information based on the location of the sound source.

In some aspects, the techniques described herein relate to a display device including: at least one processor; and a non-transitory computer-readable medium storing executable instructions that cause the at least one processor to: detect ambient noise and speech from audio data captured by a plurality of microphones on the display device; determine, based on the audio data, a first location of a first sound source of the ambient noise and a second location of a second sound source of the speech; generate first contextual information about the ambient noise based on a first audio segment of the audio data that includes the ambient noise; generate second contextual information about the speech based on a second audio segment of the audio data that includes the speech; display, by the display device, the first contextual information based on the first location of the first sound source; and display, by the display device, the second contextual information based on the second location of the second sound source.

In some aspects, the techniques described herein relate to a non-transitory computer-readable medium storing executable instructions that when executed by at least one processor cause the at least one processor to execute operations, the operations including: detecting an ambient sound from audio data captured by a plurality of microphones on a display device; determining, based on the audio data, a location of a sound source of the ambient sound; generating contextual information about the ambient sound based on an audio segment of the audio data that includes the ambient sound; and displaying, by the display device, the contextual information based on the location of the sound source.

The details of one or more implementations are set forth in the accompanying drawings and the description below. Other features will be apparent from the description and drawings, and from the claims.

### BRIEF DESCRIPTION OF THE DRA WINGS

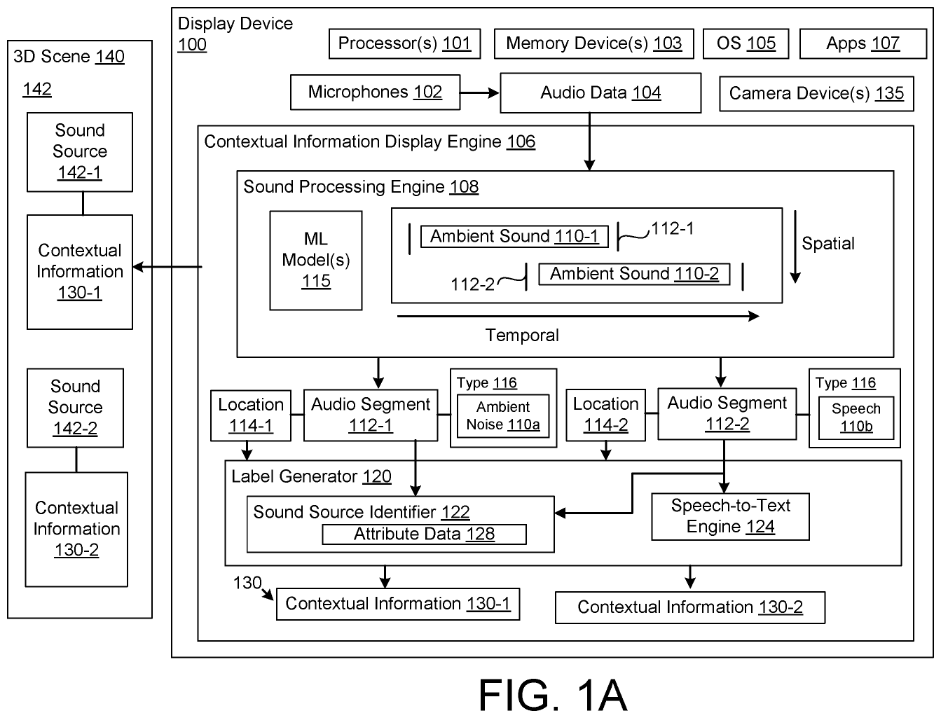

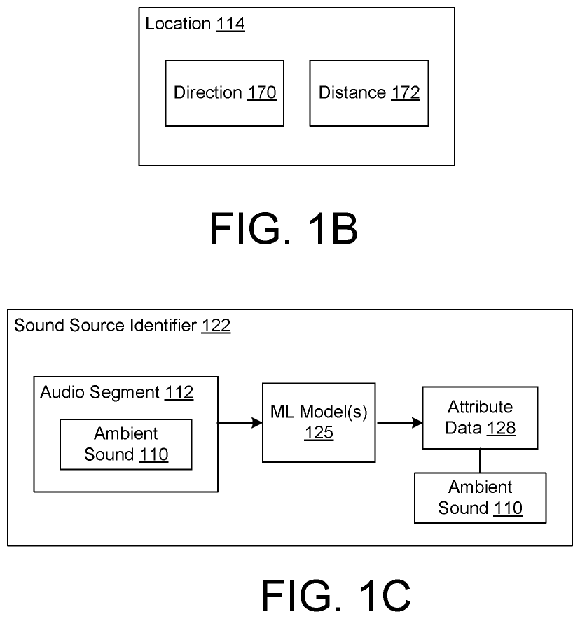

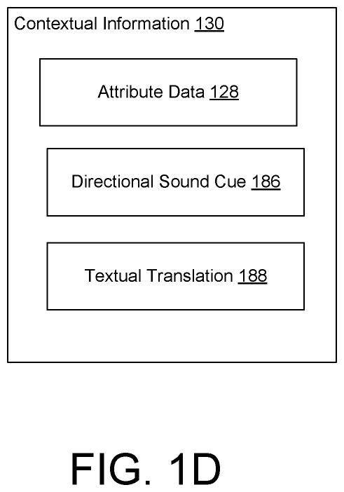

FIG. 1A illustrates a display device that generates contextual information about one or more ambient sounds according to an aspect.

FIG. 1B illustrates a perspective of a location of a sound source according to an aspect.

FIG. 1C illustrates an example of a sound source identifier that generates attribute data about an ambient source according to an aspect.

FIG. 1D illustrates an example of contextual information according to an aspect.

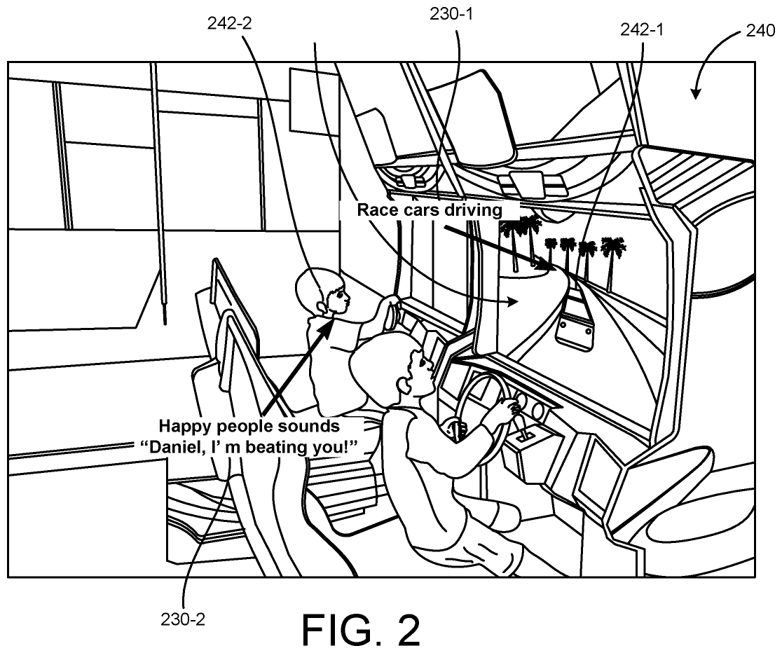

FIG. 2 illustrates an example of a three-dimensional (3D) scene with contextual information about ambient sounds according to an aspect.

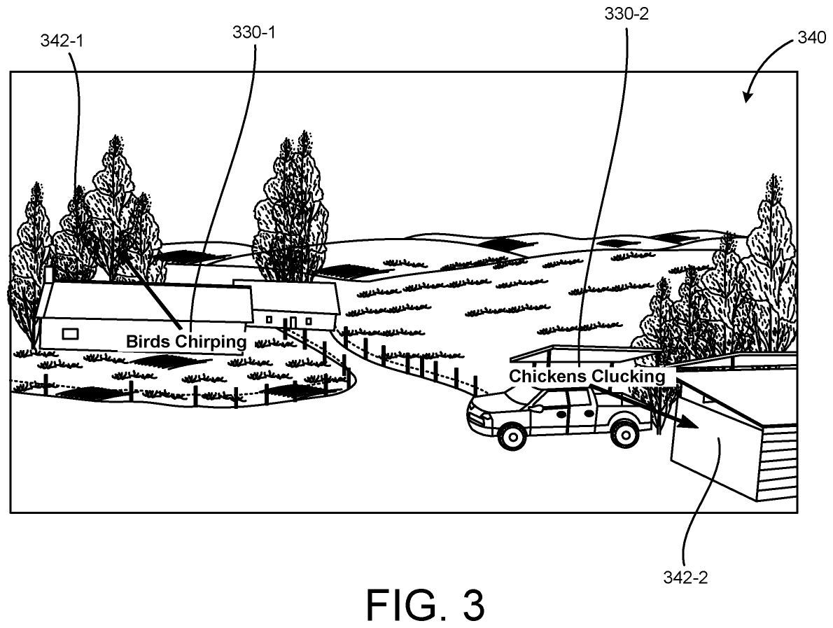

FIG. 3 illustrates an example of a 3D scene with contextual information about ambient sounds according to an aspect.

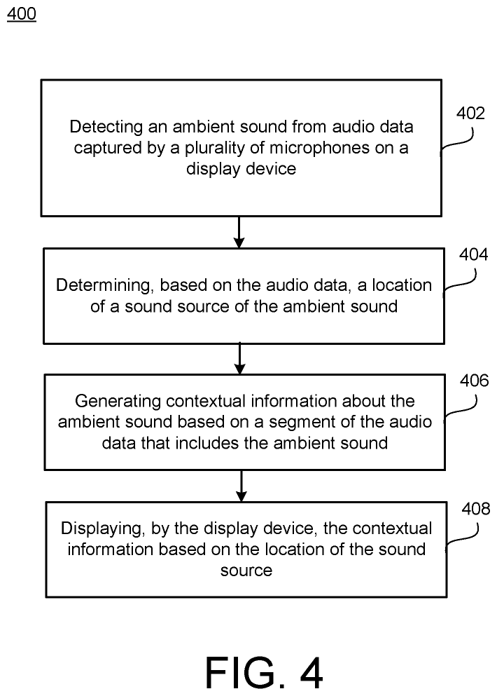

FIG. 4 illustrates a flowchart depicting example operations of a display device according to an aspect.

### DETAILED DESCRIPTION

This disclosure relates to a technical solution for a display device with a contextual information display engine that displays contextual information about one or more detected ambient sounds. In some examples, the display device is a head-mounted display device such as an augmented reality (AR) device or a virtual reality (VR) device. The display device provides a technical solution for enabling a display device with perception-enhanced directional capabilities for ambient sounds, including determining a directionality of the ambient sound (e.g., there is a honking car to your right), labeling the source of information (e.g., Matt is speaking), overlaying background audio sources into the user's experience (e.g., there is a child crying upstairs), and/or labeling attribute data (e.g., a 22-year woman is speaking on your right, saying [insert translation]). In some examples, the display device provides a technical effect for hearing-impaired users such as converting auditory sounds into visual cues for the user.

The contextual information display engine may detect speech (e.g., a type of ambient sound) and display a label with attribute data about the speaker (e.g., a twelve year-old girl is speaking) in a location that corresponds to a location of the speaker. In some examples, the contextual information display engine may display a textual transcription of the speech in a location that corresponds to the location of the speaker. In some examples, in addition to (or instead of), the contextual information display engine may detect ambient noise (e.g., a type of ambient sound), generate attribute data about the ambient noise (e.g., a car is honking), and display contextual information with the attribute data in a location that corresponds to a location of the sound source. The contextual information display engine may detect an ambient sound from audio data captured by a plurality of microphones, identifies a location (e.g., a direction and/or distance) of sound source of the ambient sound, generates attribute data about the ambient sound, and renders contextual information (e.g., a label) with the attribute data in a location that is based on the location of the ambient sound.

FIGS. 1A to 1D illustrate a display device 100 that includes a contextual information display engine 106 configured to receive audio data 104 from a plurality of microphones 102, detect an ambient sound 110 in the audio data 104, generate contextual information 130 about the ambient sound 110, and display the contextual information 130 in a location that is based on a location of a sound source that generated the ambient sound 110. For example, the contextual information display engine 106 may receive audio data 104 about the user's surroundings and display (e.g., on a display of the display device 100), contextual information 130 about one or more ambient sounds 110 in the audio data 104 in location(s) that correspond to the location of the source source(s). For example, if a user of the display device 100 is walking down a street, the contextual information display engine 106 may identify and generate attribute data 128 about the ambient sounds (e.g., a car is honking, a bell is ringing, etc.) that is around the user, including the location or direction of the relevant sound sources. In some examples, the contextual information display engine 106 may convert speech to text and may display the textual transcription in a location that is close to the speaker, and/or include information about the speaker and the direction of the speech (e.g., a 22 year old woman is saying the following, or a 22 year old woman to your right is saying the following).

The display device 100 includes a plurality of microphones 102. A microphone 102 may be a transducer that converts sound waves into electrical signals. In examples, the microphones 102 are arranged in an array to form a set of beamforming microphones. In some examples, the number of microphones 102 is equal to or four. The microphones 102 may generate audio data 104 (e.g., audio signals).

The contextual information display engine 106 includes a sound processing engine 108 configured to receive the audio data 104 captured by the microphones 102. The sound processing engine 108 may detect whether the audio data 104 includes an ambient sound 110, and, if so, may derive an audio segment 112 that includes the ambient sound 110. The audio segment 112 is a portion of the audio data 104 that includes the ambient sound 110. In some examples, the sound processing engine 108 may filter and remove background noise from the audio segment 112. In some examples, the sound processing engine 108 may detect multiple ambient sounds 110 from the audio data 104. The ambient sounds 110 may include an ambient sound 110-1 and an ambient sound 110-2. The ambient sound 110-1 is generated by a sound source 142-1. The ambient sound 110-2 is generated by a sound source 142-2. In some examples, the sound source 142-2 is located in a different (separate) location from the sound source 142-1 (e.g., a spatially different location). In some examples, the sound source 142-1 and/or the sound source 142-2 are located in an image frame of the 3D scene 140 that is within the field of view of the camera device(s) 135 (e.g., currently viewed by the user). In some examples, the sound source 142-1 and/or the sound source 142-2 are located in an image frame of the 3D scene 140 that is outside the field of view of the camera device(s) 135. In some examples, the ambient sound 110-2 at least partially overlaps with the ambient sound 110-1 (e.g., temporally overlaps). The sound processing engine 108 may derive an audio segment 112-1 that includes the ambient sound 110-1, and an audio segment 112-2 that includes the ambient sound 110-2.

The sound processing engine 108 detects a type 116 of the ambient sound 110. A type 116 may be a classification of the ambient sound 110. The sound processing engine 108 may detect the type 116 as at least one of ambient noise 110a or speech 110b. Although FIG. 1A illustrates two types of ambient sounds, the sound processing engine 1-8 may classify the ambient sound 110 according to any number of classifications, including more than one or two classifications.

In some examples, the sound processing engine 108 detects the type 116 of the ambient sound 110-1 as ambient noise 110a. Ambient noise 110a may be noise that is not human speech such as a car honking, birds chirping, a police car alarm, etc. In some examples, the sound processing engine 108 detects the type 116 of the ambient sound 110-2 as speech 110b. Speech 110b may be human speech.

The sound processing engine 108 may determine a location 114 of a sound source 142 of each detected ambient sound 110. For example, the sound processing engine 108 may determine a location 114-1 of sound source 142-1 based on the audio segment 112-1 that includes the ambient sound 110-1. The location 114 may be a direction 170 and/or a distance 172 of the sound source 142-1 from a point of reference (e.g., the user). The sound processing engine 108 may determine a location 114-2 of sound source 142-2 based on the audio segment 112-2 that includes the ambient sound 110-2. The sound processing engine 108 may include one or more machine-learning (ML) models 115.

The contextual information display engine 106 includes a label generator 120 configured to receive the output of the sound processing engine 108 and generate contextual information 130 for each detected ambient sound 110, where the contextual information 130 includes information about a detected ambient sound 110. The label generator 120 includes a sound source identifier 122 configured to generate attribute data 128 about an ambient sound 110 based on an audio segment 112. In some examples, as shown in FIG. 1C, the sound source identifier 122 includes one or more ML models 125 that receives an audio segment 112 that includes an ambient sound 110 as an input and generates attribute data 128 about the ambient sound 110 as an input. In some examples, if the type 116 is ambient noise 110a, the contextual information display engine 106 initiates the sound source identifier 122 to generate the attribute data 128. For example, the sound source identifier 122 generates attribute data 128 about the ambient sound 110-1 based on the audio segment 112-1. If the ambient sound 110-1 is a honking sound, the attribute data 128 may be textual information that describes the ambient sound 110-1 such as a “car honking.”

In some examples, the label generator 120 includes a speech-to-text engine 124 configured to generate a textual translation 188 of the speech 110b. In some examples, if the type 116 is speech 110b, the contextual information display engine 106 initiates the speech-to-text engine 124 to generate the textual translation 188 using the audio segment 112 as an input. In some examples, if the type 116 is speech 110b, the contextual information display engine 106 initiates the sound source identifier 122 to generate the attribute data 128 about the speech 110b. For example, the sound source identifier 122 generates attribute data 128 about the speech 110b based on the audio segment 112-2. If the ambient sound 110-2 is a child speaking, the attribute data 128 may be textual information that describes the speech 110b such as “a young child is speaking the following.” In some examples, if the type of speech 110b, the contextual information display engine 106 only initiates the speech-to-text engine 124 but not the sound source identifier 122.

The label generator 120 may generate contextual information 130 for each detected ambient sound 110. For example, the label generator 120 may generate contextual information 130-1 for the ambient sound 110-1, and contextual information 130-2 for the ambient sound 110-2. As shown in FIG. 1D, the contextual information 130 may include the attribute data 128. The contextual information 130 may include a directional sound cue 186. A directional sound cue 186 may be a textual description about a direction of an ambient sound 110 (e.g., a child is making noise upstairs or beyond the user). The contextual information 130 may include a textual translation 188 if the ambient sound 110-2 is speech 110b. In some examples, the contextual information 130 includes at least one of the attribute data 128, the directional sound cue 186, or the textual translation 188. When the ambient sound 110-1 is ambient noise 110a, the contextual information 130 may include at least one of attribute data 128 or a directional sound cue 186. When the ambient sound 110-2 is speech 110b, the contextual information 130 may include at least one of attribute data 128, a directional sound cue 186, or a textual translation 188.

The contextual information display engine 106 may display the contextual information 130 is a location in the 3D scene 140 that is based on (or corresponds to) a location of a sound source 142. For example, the contextual information display engine 106 may display the contextual information 130-1 at a location in the 3D scene 140 that is based on (or corresponds) to a location 114-1 of a sound source 142-1, and the contextual information display engine 106 may display the contextual information 130-2 at a location in the 3D scene 140 that is based on (or corresponds) to a location 114-2 of a sound source 142-2.

The display device 100 may include one or more processors 101, one or more memory devices 103, and an operating system 105 configured to execute one or more applications 107. In some examples, the display device 100 is a head-mounted display device. In some examples, the display device 100 includes an AR device (e.g., a device that superimposes virtual content on a user's view of the real world, thereby providing a composite view). In some examples, the display device 100 includes smart glasses. In some examples, the display device 100 includes a VR device, where the camera device(s) 135 are world-facing cameras that capture the user's surroundings, and the VR device generates virtual content that corresponds to the imagery captured by the camera device(s) 135. In some examples, the display device 100 is another type of user device such as a smartphone, a laptop, desktop, gaming console, or a television device.

The processor(s) 101 may be formed in a substrate configured to execute one or more machine executable instructions or pieces of software, firmware, or a combination thereof. The processor(s) 101 can be semiconductor-based-that is, the processors can include semiconductor material that can perform digital logic. The memory device(s) 103 may include any type of storage device that stores information in a format that can be read and/or executed by the processor(s) 101. In some examples, the memory device(s) 103 is/are a non-transitory computer-readable medium. In some examples, the memory device(s) 103 includes a non-transitory computer-readable medium that includes executable instructions that cause at least one processor (e.g., the processor(s) 101) to execute operations discussed with reference to the display device 100. The applications 107 may be any type of computer program that can be executed by the display device 100, including native applications that are installed on the operating system 105 by the user and/or system applications that are pre-installed on the operating system 105.

FIG. 2 illustrates a perspective of a 3D scene 240 that displays contextual information about ambient sounds according to an aspect. For example, the contextual information display engine 106 of FIGS. 1A to ID may display contextual information 230-1 about an ambient sound in a location that corresponds to a location of a sound source 242-1. The contextual information 230-1 includes attribute data (e.g., “race cars driving”) about the ambient sound. The contextual information 230-1 is displayed in a location that corresponds to the video game machine that generated the ambient sound. The contextual information display engine 106 of FIGS. 1A to ID may display contextual information 230-2 about an ambient sound in a location that corresponds to a location of a sound source 242-2. The contextual information 230-2 may include attribute data (e.g., “Happy Children Sounds”) and a textual transcription (e.g., “Daniel, I′m beating you”). The contextual information 230-2 is displayed in a location that corresponds to the child that generated the ambient sound.

FIG. 3 illustrates a perspective of a 3D scene 340 that displays contextual information about ambient sounds according to an aspect. For example, the contextual information display engine 106 of FIGS. 1A to 1D may display contextual information 330-1 about an ambient sound in a location that corresponds to a location of a sound source 342-1. The contextual information 330-1 includes attribute data (e.g., “Birds Chirping”) about the ambient sound. The contextual information 330-1 is displayed in a location that corresponds to the sound source 342-1 that generated the ambient sound. The contextual information display engine 106 of FIGS. 1A to 1D may display contextual information 330-2 about an ambient sound in a location that corresponds to a location of a sound source 342-2. The contextual information 330-2 may include attribute data (e.g., “Chickens Clucking”). The contextual information 330-2 is displayed in a location that corresponds to the sound source 342-2 that generated the ambient sound.

FIG. 4 is a flowchart 400 depicting example operations of a display device according to an aspect. The flowchart 400 may depict operations of a computer-implemented method. Although the flowchart 400 is explained with respect to the display device 100 of FIGS. 1A to 1D, the flowchart 400 may be applicable to any of the implementations discussed herein. Although the flowchart 400 of FIG. 4 illustrates the operations in sequential order, it will be appreciated that this is merely an example, and that additional or alternative operations may be included. Further, operations of FIG. 4 and related operations may be executed in a different order than that shown, or in a parallel or overlapping fashion.

Operation 402 includes detecting an ambient sound from audio data captured by a plurality of microphones on a display device. Operation 404 includes determining, based on the audio data, a location of a sound source of the ambient sound. Operation 406 includes generating contextual information about the ambient sound based on a segment of the audio data that includes the ambient sound. Operation 408 includes displaying, by the display device, the contextual information based on the location of the sound source.
Clause 1. A method comprising: detecting an ambient sound from audio data captured by a plurality of microphones on a display device; determining, based on the audio data, a location of a sound source of the ambient sound; generating contextual information about the ambient sound based on an audio segment of the audio data that includes the ambient sound; and displaying, by the display device, the contextual information based on the location of the sound source.
Clause 2. The method of clause 1, further comprising: generating attribute data about the sound source; and generating the contextual information to include the attribute data.
Clause 3. The method of clause 1, further comprising: detecting that the audio data includes speech; converting the speech to text; and generating the contextual information to include the text.
Clause 4. The method of clause 1, wherein determining the location of the sound source of the ambient sound includes: determining, by a machine-learning (ML) model, a direction and a distance of the ambient sound.
Clause 5. The method of clause 1, further comprising: identifying, by a machine-learning (ML) model, the audio segment of the audio data that includes the ambient sound from the audio data; and removing background noise from the audio segment.
Clause 6. The method of clause 1, wherein the contextual information includes a textual translation of the ambient sound.
Clause 7. The method of clause 1, wherein the contextual information includes a directional sound cue about a direction of the ambient sound.
Clause 8. A display device comprising: at least one processor; and a non-transitory computer-readable medium storing executable instructions that cause the at least one processor to: detect ambient noise and speech from audio data captured by a plurality of microphones on the display device; determine, based on the audio data, a first location of a first sound source of the ambient noise and a second location of a second sound source of the speech; generate first contextual information about the ambient noise based on a first audio segment of the audio data that includes the ambient noise; generate second contextual information about the speech based on a second audio segment of the audio data that includes the speech; display, by the display device, the first contextual information based on the first location of the first sound source; and display, by the display device, the second contextual information based on the second location of the second sound source.
Clause 9. The display device of clause 8, wherein the executable instructions include instructions that cause the at least one processor to: generate attribute data about the first sound source based on the first audio segment; and generate the first contextual information to include the attribute data.
Clause 10. The display device of clause 8, wherein the executable instructions include instructions that cause the at least one processor to: generate attribute data about the second sound source; convert the speech to text; and generate the second contextual information to include the text and the attribute data.
Clause 11. The display device of clause 8, wherein the executable instructions include instructions that cause the at least one processor to: determine, by a machine-learning (ML) model, a direction and a distance of the ambient noise.
Clause 12. The display device of clause 8, wherein the executable instructions include instructions that cause the at least one processor to: identify, by a first machine-learning (ML) model, the first audio segment of the audio data that includes the ambient noise from the audio data; removing background noise from the first audio segment; generate, by a second ML model, attribute data about the ambient noise using the first audio segment; and generate the first contextual information to include the attribute data.
Clause 13. The display device of clause 8, wherein the second contextual information includes a textual translation of the speech.
Clause 14. The display device of clause 8, wherein the second contextual information includes a directional sound cue about a direction of the speech.
Clause 15. The display device of clause 8, wherein the display device is smart glasses, and the plurality of microphones are coupled to a frame of the smart glasses.
Clause 16. A non-transitory computer-readable medium storing executable instructions that when executed by at least one processor cause the at least one processor to execute operations, the operations comprising: detecting an ambient sound from audio data captured by a plurality of microphones on a display device; determining, based on the audio data, a location of a sound source of the ambient sound; generating contextual information about the ambient sound based on an audio segment of the audio data that includes the ambient sound; and displaying, by the display device, the contextual information based on the location of the sound source.
Clause 17. The non-transitory computer-readable medium of clause 16, wherein the operations further comprise: generating attribute data about the sound source; and generating the contextual information to include the attribute data.
Clause 18. The non-transitory computer-readable medium of clause 16, wherein the operations further comprise: detecting that the audio data includes speech; converting the speech to text; and generating the contextual information to include the text.
Clause 19. The non-transitory computer-readable medium of clause 16, wherein the operations further comprise: determining, by a machine-learning (ML) model, a direction and a distance of the ambient sound.
Clause 20. The non-transitory computer-readable medium of clause 16, wherein the operations further comprise: identifying, by a machine-learning (ML) model, the audio segment of the audio data that includes the ambient sound from the audio data; and removing background noise from the audio segment.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

In this specification and the appended claims, the singular forms “a,” “an” and “the” do not exclude the plural reference unless the context clearly dictates otherwise. Further, conjunctions such as “and,” “or,” and “and/or” are inclusive unless the context clearly dictates otherwise. For example, “A and/or B” includes A alone, B alone, and A with B. Further, connecting lines or connectors shown in the various figures presented are intended to represent example functional relationships and/or physical or logical couplings between the various elements. Many alternative or additional functional relationships, physical connections or logical connections may be present in a practical device. Moreover, no item or component is essential to the practice of the implementations disclosed herein unless the element is specifically described as “essential” or “critical”.

Terms such as, but not limited to, approximately, substantially, generally, etc. are used herein to indicate that a precise value or range thereof is not required and need not be specified. As used herein, the terms discussed above will have ready and instant meaning to one of ordinary skill in the art.

Moreover, use of terms such as up, down, top, bottom, side, end, front, back, etc. herein are used with reference to a currently considered or illustrated orientation. If they are considered with respect to another orientation, it should be understood that such terms must be correspondingly modified.

Although certain example methods, apparatuses and articles of manufacture have been described herein, the scope of coverage of this patent is not limited thereto. It is to be understood that terminology employed herein is for the purpose of describing particular aspects and is not intended to be limiting. On the contrary, this patent covers all methods, apparatus and articles of manufacture fairly falling within the scope of the claims of this patent.

What is claimed is:

1. A method comprising:
detecting an ambient sound from audio data captured by a plurality of microphones on a display device;
determining, based on the audio data, a location of a sound source of the ambient sound;
generating contextual information about the ambient sound based on an audio segment of the audio data that includes the ambient sound; and
displaying, by the display device, the contextual information based on the location of the sound source.

2. The method of claim 1, further comprising:
generating attribute data about the sound source; and
generating the contextual information to include the attribute data.

3. The method of claim 1, further comprising:
detecting that the audio data includes speech;
converting the speech to text; and
generating the contextual information to include the text.

4. The method of claim 1, wherein determining the location of the sound source of the ambient sound includes:
determining, by a machine-learning (ML) model, a direction and a distance of the ambient sound.

5. The method of claim 1, further comprising:
identifying, by a machine-learning (ML) model, the audio segment of the audio data that includes the ambient sound from the audio data; and
removing background noise from the audio segment.

6. The method of claim 1, wherein the contextual information includes a textual translation of the ambient sound.

7. The method of claim 1, wherein the contextual information includes a directional sound cue about a direction of the ambient sound.

8. A display device comprising:
at least one processor; and
a non-transitory computer-readable medium storing executable instructions that cause the at least one processor to:
detect ambient noise and speech from audio data captured by a plurality of microphones on the display device;
determine, based on the audio data, a first location of a first sound source of the ambient noise and a second location of a second sound source of the speech;
generate first contextual information about the ambient noise based on a first audio segment of the audio data that includes the ambient noise;
generate second contextual information about the speech based on a second audio segment of the audio data that includes the speech;
display, by the display device, the first contextual information based on the first location of the first sound source; and
display, by the display device, the second contextual information based on the second location of the second sound source.

9. The display device of claim 8, wherein the executable instructions include instructions that cause the at least one processor to:
generate attribute data about the first sound source based on the first audio segment; and
generate the first contextual information to include the attribute data.

10. The display device of claim 8, wherein the executable instructions include instructions that cause the at least one processor to:
generate attribute data about the second sound source;
convert the speech to text; and
generate the second contextual information to include the text and the attribute data.

11. The display device of claim 8, wherein the executable instructions include instructions that cause the at least one processor to:
determine, by a machine-learning (ML) model, a direction and a distance of the ambient noise.

12. The display device of claim 8, wherein the executable instructions include instructions that cause the at least one processor to:
identify, by a first machine-learning (ML) model, the first audio segment of the audio data that includes the ambient noise from the audio data;
removing background noise from the first audio segment;
generate, by a second ML model, attribute data about the ambient noise using the first audio segment; and
generate the first contextual information to include the attribute data.

13. The display device of claim 8, wherein the second contextual information includes a textual translation of the speech.

14. The display device of claim 8, wherein the second contextual information includes a directional sound cue about a direction of the speech.

15. The display device of claim 8, wherein the display device is a head-mounted display device, and the plurality of microphones are coupled to a frame of the head-mounted display device.

16. A non-transitory computer-readable medium storing executable instructions that when executed by at least one processor cause the at least one processor to execute operations, the operations comprising:
detecting an ambient sound from audio data captured by a plurality of microphones on a display device;
determining, based on the audio data, a location of a sound source of the ambient sound;
generating contextual information about the ambient sound based on an audio segment of the audio data that includes the ambient sound; and
displaying, by the display device, the contextual information based on the location of the sound source.

17. The non-transitory computer-readable medium of claim 16, wherein the operations further comprise:
generating attribute data about the sound source; and
generating the contextual information to include the attribute data.

18. The non-transitory computer-readable medium of claim 16, wherein the operations further comprise:
detecting that the audio data includes speech;
converting the speech to text; and
generating the contextual information to include the text.

19. The non-transitory computer-readable medium of claim 16, wherein the operations further comprise:
determining, by a machine-learning (ML) model, a direction and a distance of the ambient sound.

20. The non-transitory computer-readable medium of claim 16, wherein the operations further comprise:
identifying, by a machine-learning (ML) model, the audio segment of the audio data that includes the ambient sound from the audio data; and
removing background noise from the audio segment.
